(19) United States
(12) Patent Application Publication
(10) Pub. No.: US 2013/0008546 A1
(43) Pub. Date: Jan. 10, 2013

(54) BALLOON STYLE FLUID FLOW CONTROL ARRANGEMENT

(76) Inventor: Shlomo Uri HAIMI, Or Akiva (IL)

(21) Appl. No.: 13/175,972

(22) Filed: Jul. 5, 2011

(51) Int. Cl. F16L 55/10

(52) U.S. Cl. 138/89

(57) ABSTRACT

A fluid flow control arrangement for controlling the flow of fluid within a pipeline, the fluid flow control arrangement having a flow control arrangement housing associated with a fluid flow pipeline and a valve plug element displaceable within the flow control arrangement housing, wherein the valve plug element has elastic characteristics such that the valve plug element assumes at least a first shape in which the fluid flow path within the pipe is open and fluid flows unrestricted and the valve plug element assumes at least a second shape in which the valve plug element blocks a fluid flow path within the pipe so as to stop fluid flow within the pipeline.

### FIELD AND BACKGROUND OF THE INVENTION

The present invention relates to fluid control valves and, in particular, it concerns a simple balloon style fluid flow control arrangement in which the valve plug is implemented as a balloon and which requires no valve seat per se.

It is known to control the flow of fluid through a pipe by means of a valve. Such flow control valves may be located along a length of pipe or at the terminal end and configured as an outlet tap.

Conventional flow control valves include a displaceable plug that is pressed against a stationary valve seat.

Such conventional flow control valves suffer from a number of issues, among them being the disruption of smooth flow through the pipe due to the placement of the valve. Another drawback is the cost of manufacture due to casting and milling necessary to produce such valves.

There is therefore a need for a simple balloon style fluid flow control arrangement in which the valve plug is implemented as a balloon and which requires no valve seat per se.

### SUMMARY OF THE INVENTION

The present invention is a simple balloon style fluid flow control arrangement in which the valve plug is implemented as a balloon and which requires no valve seat per se

According to the teachings of the present invention there is provided, a fluid flow control arrangement for controlling the flow of fluid within a pipeline, the fluid flow control arrangement comprising: (a) a flow control arrangement housing associated with the pipeline; and (b) a valve plug element displaceable within the flow control arrangement housing; wherein the valve plug element has elastic characteristics such that the valve plug element assumes at least a first shape in which the fluid flow path within the pipe is open and fluid flows unrestricted and the valve plug element assumes at least a second shape in which the valve plug element blocks a fluid flow path within the pipe so as to stop fluid flow within the pipeline.

According to a further teaching of the present invention, the valve plug element is longitudinally displaceable within the flow control arrangement housing.

According to a further teaching of the present invention, a transition between the first shape and the second shape is affected by an amount of fluid displaced into an inflatable region of the valve plug element such that at least a portion of the inflatable region expands into an interior region of the pipeline and thereby at least partially blocks the flow of fluid through the pipeline.

According to a further teaching of the present invention, the fluid displaced into the inflatable region of the valve plug element is at least one chosen from a list that includes: compressible gas, non-compressible gas, compressible liquid, non-compressible liquid, compressible gel and non-compressible gel.

According to a further teaching of the present invention, a transition between the first shape and the second shape is affected by pressing the valve plug element against an interior wall of the pipeline such that the soft and flexible outer layer deforms thereby creating a fluid flow resistant seal between the valve plug element and the interior wall of the pipeline.

According to a further teaching of the present invention, the valve plug element includes a soft and flexible outer layer.

According to a further teaching of the present invention, the pipeline is configured as an outlet tap.

There is also provided according to the teachings of the present invention, a method for controlling the flow of fluid within a pipeline, the method comprising: (a) providing a fluid flow control arrangement having: (i) a flow control arrangement housing associated with the pipeline; and (ii) a valve plug element displaceable within the flow control arrangement housing; wherein the valve plug element has elastic characteristics such that the valve plug element assumes at least a first shape in which the fluid flow path within the pipe is open and fluid flows unrestricted and the valve plug element assumes at least a second shape in which the valve plug element blocks a fluid flow path within the pipe so as to stop fluid flow within the pipeline; (b) displacing the valve plug element so as to transition the valve plug element between the first shape and second shape.

According to a further teaching of the present invention, the valve plug element is implemented so as to be longitudinally displaceable within the flow control arrangement housing.

According to a further teaching of the present invention, the transition between the first shape and the second shape is implemented by displacing an amount of fluid into an inflatable region of the valve plug element such that at least a portion of the inflatable region expands into an interior region of the pipeline and thereby at least partially blocks the flow of fluid through the pipeline.

According to a further teaching of the present invention, the fluid displaced into the inflatable region of the valve plug element is implemented as at least one chosen from a list that includes: compressible gas, non-compressible gas, compressible liquid, non-compressible liquid, compressible gel and non-compressible gel.

According to a further teaching of the present invention, a transition between the first shape and the second shape is implemented by pressing the valve plug element against an interior wall of the pipeline such that the soft and flexible outer layer deforms thereby creating a fluid flow resistant seal between the valve plug element and the interior wall of the pipeline.

According to a further teaching of the present invention, the valve plug element provided with a soft and flexible outer layer.

According to a further teaching of the present invention, the pipeline is implemented as an outlet tap.

### BRIEF DESCRIPTION OF THE DRAWINGS

The invention is herein described, by way of example only, with reference to the accompanying drawings, wherein:

FIGS. 1A-1D are section views of a first embodiment of a balloon style fluid flow control arrangement constructed and operational according to the teachings of the present invention, in which FIGS. 1A and 1B are side elevations and FIGS. 1C and 1D are end elevations;

FIGS. 2A-2D are section views of a second embodiment of a balloon style fluid flow control arrangement constructed and operational according to the teachings of the present invention, in which FIGS. 2B and 2D are side elevations and FIGS. 2A and 2C are end elevations;

FIGS. 3A-5 are side sections illustrating variations of a balloon style fluid flow control arrangements that may be applied to substantially any embodiment of the present invention; and

FIGS. 6A-6D are section views illustrating a variant actuating arrangement that may be applied to substantially any embodiment of the present invention.

### DESCRIPTION OF THE PREFERRED EMBODIMENTS

The present invention is a simple balloon style fluid flow control arrangement in which the valve plug is implemented as a balloon and which requires no valve seat per se.

The principles and operation of balloon style fluid flow control arrangement according to the present invention may be better understood with reference to the drawings and the accompanying description.

By way of introduction, it should be noted that while the present invention may be implemented in numerous embodiments, the underlying principles are the same, to provide a valve plug element having elastic characteristics allowing the valve plug element to assume at least one shape in which the fluid flow path within the pipe is open and fluid flows unrestricted and further allows the valve plug element to assume at least another shape in which the valve plug element blocks the fluid flow path within the pipe so as to stop fluid flow within the pipe.

It will be appreciated that the balloon style fluid flow control arrangement of the present invention may be used to benefit in pipelines in which the fluid is in a gaseous state a liquid state or a solid state such as powder and granulated substances.

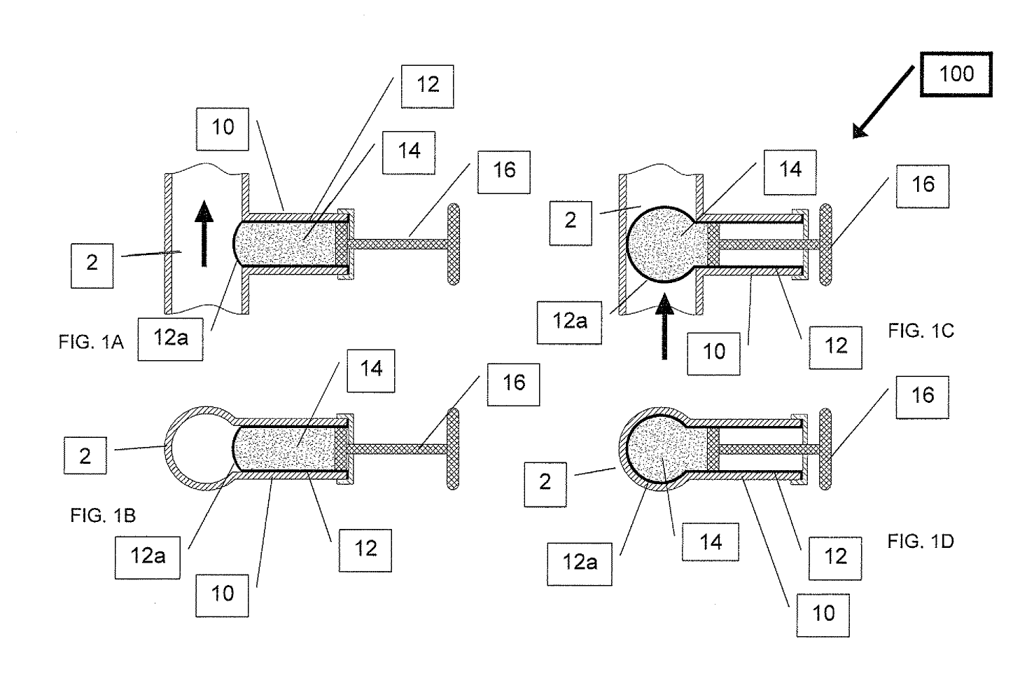

Referring now to the drawings, in the first preferred embodiment 100 of the present invention illustrated in FIGS. 1A-1D, extending from pipe 2 is the flow control arrangement housing 10. The housing 10 is configured so as to have at least a partial opening into the interior of pipe 2. The valve plug element deployed within the housing 10 is configured as a balloon element 12, in which is contains a predetermined amount of fluid material 14, and an actuator 16. Note that an inflatable region 12a of the balloon element 12 extends across the opening between housing 10 and pipe 2. In this embodiment of the present invention, the actuator 16 is configured as a syringe type mechanism. It should be noted that although the housing 10 is illustrated as extending perpendicularly from pipe 2, this is for illustration purposes only and is not intended as a limitation, any suitable angular relation between the housing 10 and pipe 2 is within the scope of the present invention.

In operation, when the actuator 16 is displaced inwardly into the housing 10 the fluid 14 stored within balloon element 12 is also displaced, thereby causing at least a portion of inflatable region 12a of the balloon element 12 to inflate into the interior region of pipe 2 and thereby at least partially block the flow of fluid through pipe 2. That is to say, due to the elastic characteristics of the material from which the balloon element is produced, displacement of fluid 14 toward the distal end of housing 10 causes at least a portion of inflatable region 12a of the balloon element 12 to stretch creating an enlargement of region 12a filled with fluid 14 that extends into the interior region of pipe 2. It will be appreciated that the degree of inflation (enlargement) determines the amount of blockage and that full inflation of inflatable region 12a will cause full blockage of the fluid flow in pipe 2.

Likewise, displacement of actuator 16 outwardly in the housing 10 will draw at least a portion of the fluid 14 out of the enlarged inflatable region 12a of the balloon element 12, thereby reducing the size of the enlarged inflatable region 12a and also reducing the amount of blockage of the fluid flow within pipe 2.

It will be appreciated that both the material from which balloon element 12 is produced and the fluid material 14 may be varied according to the requirements of a particular application. That is, the strength and elastic characteristics of the balloon and the characteristics of fluid 14 are chosen based on the specifications of the specific job such as, but not limited to diameter of the pipe 2, type of fluid flowing through pipe 2, physical state of the fluid flowing through pipe 2 (gas, liquid or solid) and the operational pressure of the fluid flowing through pipe 2. It should be noted that fluid 14 may be implemented, by non-limiting example, as a compressible or non-compressible gas, liquid or gel as required.

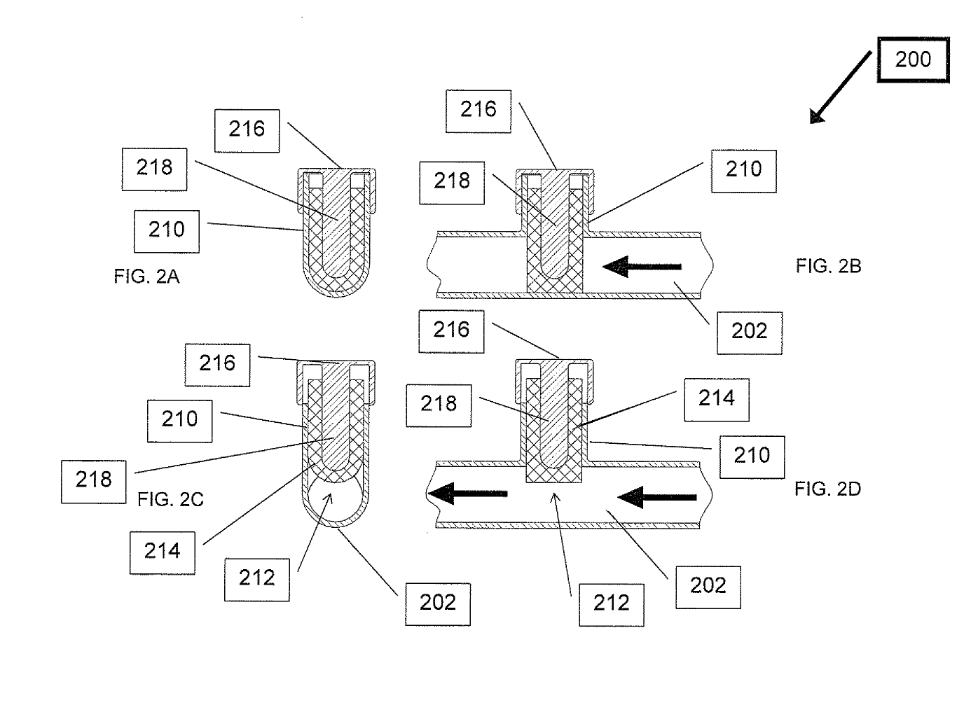

FIG. 2 illustrates a second preferred embodiment 200 of the present invention in which the valve plug element 212 is longitudinally displaceable within the flow control arrangement housing 210 that extends at an angle (illustrated here as perpendicular solely for exemplary purposes) from pipe 202. Valve plug element 212 includes an outer layer 214 configured from a soft and flexible substance that has elastic characteristics such that outer layer 214 deforms so as to assume another shape when pressed against the wall of pipe 202 so as to stop fluid flow within the pipe 202.

In operation, when the actuator 216 is displaced inwardly into the housing 210 the valve plug element 212 stored within housing 210 is also displaced, thereby causing at least a portion of valve plug element 212 into the interior region of pipe 202 and thereby at least partially blocking the flow of fluid through pipe 202. Full displacement of actuator 216 toward the distal end of housing 210 causes outer layer 214 to press against the wall of pipe 202 causing full blockage of the fluid flow in pipe 202.

Likewise, displacement of actuator 216 outwardly in the housing 210 will draw at least a portion of valve plug element 212 into housing 210, thereby reducing the amount of valve plug element 212 extending into the flow path of pipe 202 and also reducing the amount of blockage of the fluid flow within pipe 202.

It will be appreciated that the size (length, width, thickness) may be varied depending on, by non-limiting example) engineering, production and/or application requirements relating to construction materials or the fluid to be controlled.

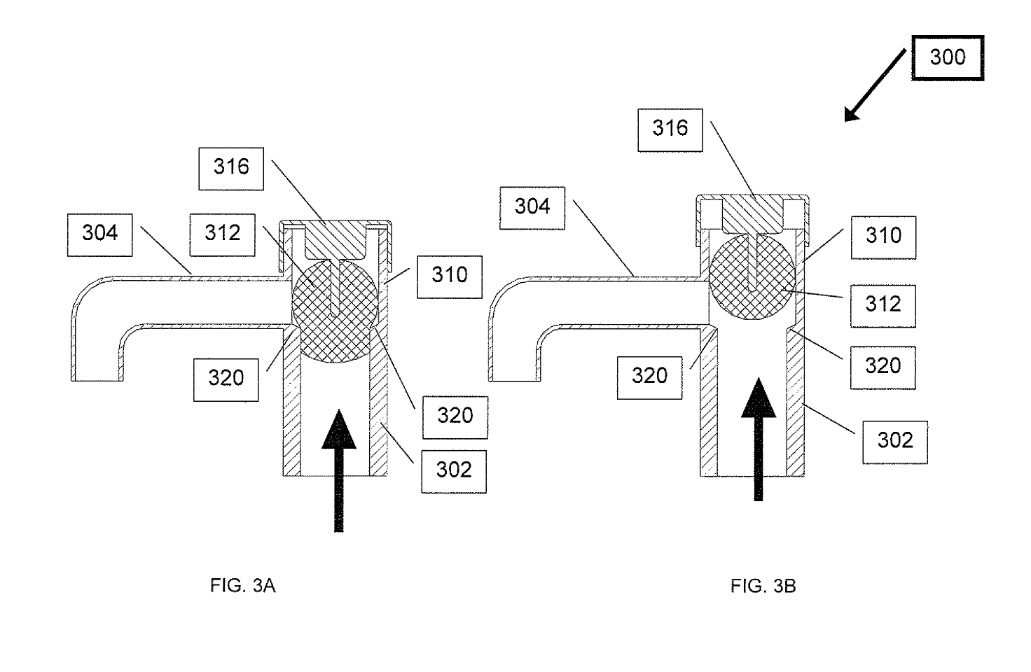

FIGS. 3A and 3B illustrate a number of variations that include locating the valve arrangement 300 at a turning point in pipe 302. Illustrated here is a transition from the pipeline 302 to an outlet tap 304 that extends from pipe 302 at an angle, shown here as perpendicular solely for illustrative purposes with no limitation to the principles of the present invention intended. Therefore, the flow control valve housing 310 extends longitudinally from the end of pipe 302.

As illustrated here, the inside diameter of the housing 310 is larger that the inside diameter of pipe 302, thereby forming a lip 320 at the terminal end of pipe 302. With such a configuration, when the valve plug element 312 is displaced longitudinally within housing 310 toward pipe 302 the valve plug element 312 at least partially obstructs the fluid flow path between pipe 302 and outlet tap 304. Upon full displacement of the valve plug element 312 is displaced longitudinally within housing 310 toward pipe 302 the valve plug element 312 is pressed against lip 320. Optionally, or additionally, a portion of the valve plug element 312 extends into pipe 302 and is pressed against the inside wall of pipe 302 as seen in FIG. 3A.

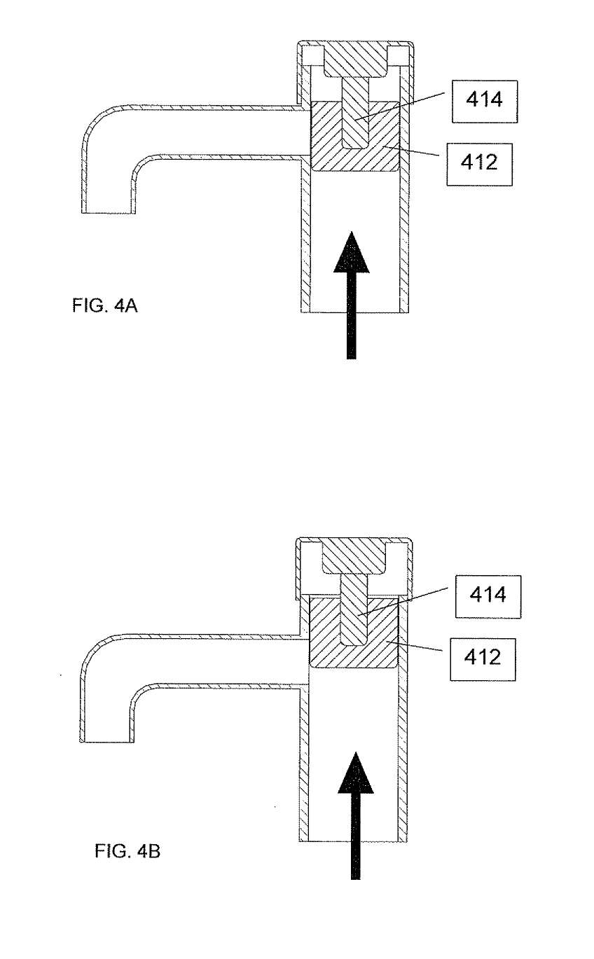

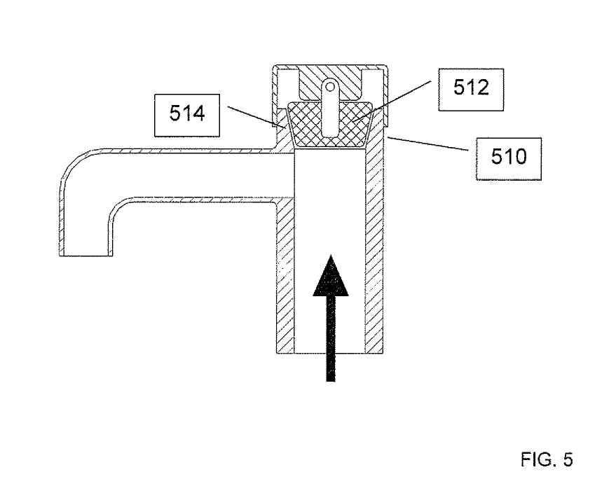

It should be noted that the illustration of the valve plug element 312 as a sphere is intended not as a limitation to the present invention, but rather as an example of a variant shape for the valve plug element, as are the cube of FIGS. 4A and 4B and the three-dimensional trapezoid of FIG. 5.

The valve plug element 412 of FIGS. 4A and 4B includes an inner support structure 414 that is larger than it's counter part in FIGS. 3A and 3B, thereby illustrating that the size, shape and/or length of the inner support structures of any of the embodiments of the present invention may be varied as required due to such issues as, but not limited to, high fluid\air pressures within pipeline being controlled.

As mentioned above, the valve plug element 512 of FIG. 5 is a three-dimensional trapezoid. In order to accommodate such a shape, the interior walls of flow control valve housing 510 is configured with interior walls define a space corresponding to the shape of the valve plug element 512.

Therefore, it should be noted that wide variety of shapes can be used for the purpose of fluid\air blockage, an additional option, for purposes of example only, is a cylinder or cone shaped valve plug element.

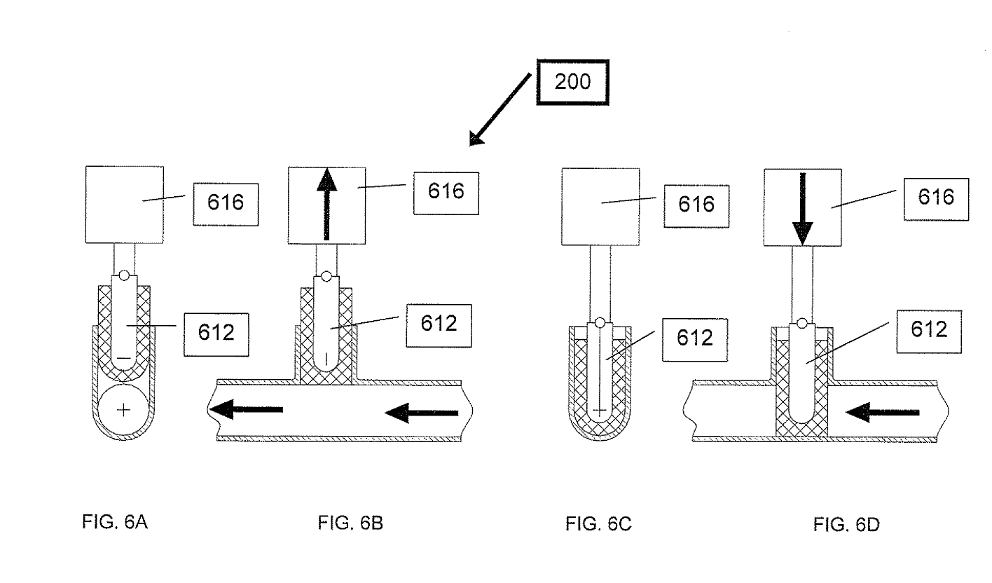

The fluid flow control valve arrangement of FIG. 6 illustrates the use of automated actuators 616 for the displacement of the valve plug element 612. It will be appreciated that such automated actuators may be, but not limited to, electrically, pneumatically, hydraulically and magnetically operated, for example.

It will be understood, then, that the manually operated actuators may be configured for direct longitudinal displacement or rotational operation of screw threads both of which are common in the art. It should be noted that an embodiment that is configured for direct longitudinal displacement of the actuator is well suited for emergency locks and fluid flow cut-out valves.

It will be appreciated that fluid flow control valves of the present invention may be used to benefit in a variety of areas within the art. Such areas include, but are not limited to,

1. Taps for traditional industry needs.

2. Taps for air pressure\hydraulics and operators in this field.

3. Taps for the transfer of powder or granular substances in the industrial and pharmaceutical fields.

4. The chemical industry.

5. Emergency taps for air\fluid

6. Agriculture.

7. Infrastructure.

8. Electrical taps with a linear rather than circular operation.

9. Medical: medication transfer, intravenous infusion.

10. Taps for domestic use such as hot and cold water supply lines and outlet taps.

It will be appreciated that the above descriptions are intended only to serve as examples and that many other embodiments are possible within the spirit and the scope of the present invention.

What is claimed is:

1. A fluid flow control arrangement for controlling the flow of fluid within a pipeline, the fluid flow control arrangement comprising:
(a) a flow control arrangement housing associated with the pipeline; and
(b) a valve plug element displaceable within said flow control arrangement housing;
wherein said valve plug element has elastic characteristics such that said valve plug element assumes at least a first shape in which the fluid flow path within the pipe is open and fluid flows unrestricted and said valve plug element assumes at least a second shape in which said valve plug element blocks a fluid flow path within the pipe so as to stop fluid flow within the pipeline.

2. The fluid flow control arrangement of claim 1, wherein said valve plug element is longitudinally displaceable within said flow control arrangement housing.

3. The fluid flow control arrangement of claim 1, wherein a transition between said first shape and said second shape is affected by an amount of fluid displaced into an inflatable region of said valve plug element such that at least a portion of said inflatable region expands into an interior region of the pipeline and thereby at least partially blocks the flow of fluid through the pipeline.

4. The fluid flow control arrangement of claim 3, wherein said fluid displaced into said inflatable region of said valve plug element is at least one chosen from a list that includes: compressible gas, non-compressible gas, compressible liquid, non-compressible liquid, compressible gel and non-compressible gel.

5. The fluid flow control arrangement of claim 1, wherein a transition between said first shape and said second shape is affected by pressing said valve plug element against an interior wall of the pipeline such that said soft and flexible outer layer deforms thereby creating a fluid flow resistant seal between said valve plug element and said interior wall of the pipeline.

6. The fluid flow control arrangement of claim 5, wherein said valve plug element includes a soft and flexible outer layer.

7. The fluid flow control arrangement of claim 1, wherein the pipeline is configured as an outlet tap.

8. A method for controlling the flow of fluid within a pipeline, the method comprising:
(a) providing a fluid flow control arrangement having:
(i) a flow control arrangement housing associated with the pipeline; and
(ii) a valve plug element displaceable within said flow control arrangement housing;
wherein said valve plug element has elastic characteristics such that said valve plug element assumes at least a first shape in which the fluid flow path within the pipe is open and fluid flows unrestricted and said valve plug element assumes at least a second shape in which said valve plug element blocks a fluid flow path within the pipe so as to stop fluid flow within the pipeline;
(b) displacing said valve plug element so as to transition said valve plug element between said first shape and second shape.

9. The method of claim 8, wherein said valve plug element is implemented so as to be longitudinally displaceable within said flow control arrangement housing.

10. The method of claim 8, wherein said transition between said first shape and said second shape is implemented by displacing an amount of fluid into an inflatable region of said valve plug element such that at least a portion of said inflatable region expands into an interior region of the pipeline and thereby at least partially blocks the flow of fluid through the pipeline.

11. The method of claim 10, wherein said fluid displaced into said inflatable region of said valve plug element is implemented as at least one chosen from a list that includes: compressible gas, non-compressible gas, compressible liquid, non-compressible liquid, compressible gel and non-compressible gel.

12. The method of claim 8, wherein a transition between said first shape and said second shape is implemented by pressing said valve plug element against an interior wall of the pipeline such that said soft and flexible outer layer deforms thereby creating a fluid flow resistant seal between said valve plug element and said interior wall of the pipeline.

13. The method of claim 12, wherein said valve plug element provided with a soft and flexible outer layer.

14. The method of claim 8, wherein the pipeline is implemented as an outlet tap.
